(19) United States
(12) Patent Application Publication
(10) Pub. No.: US 2020/0297135 A1
(43) Pub. Date: Sep. 24, 2020

(54) HOTEL BED PILLOW

(71) Applicant: Bharat Patel, Boynton Beach, FL (US)

(72) Inventor: Bharat Patel, Boynton Beach, FL (US)

(21) Appl. No.: 16/358,696

(22) Filed: Mar. 20, 2019

(51) Int. Cl. A47G 9/10; G09F 3/00; G09F 23/00

(52) U.S. Cl. CPC A47G 9/10; A47G 2009/1018; G09F 23/00; G09F 3/00

(57) ABSTRACT

A rectangular bed pillow has a longitudinal upper border having a proximal end and a distal end and a longitudinal lower border parallel to the longitudinal upper border. A first side border is connected to the proximal ends of the upper border and the lower border. A second side border is connected to the distal ends of the upper border and the lower border. A longitudinal partition is disposed parallel to the upper border and the lower border extending between the first and second side borders, forming an upper portion and a lower portion of the pillow. A first quantity of filling material fills the upper portion of the pillow and a second quantity of filling material fills the lower portion of the pillow, so the upper portion of the pillow has a first thickness and the lower portion of the pillow has a second thickness.

### FIELD OF THE INVENTION

The present invention pertains to bed pillows and, more particularly, to a bed pillow having two sections with different thicknesses.

### BACKGROUND OF THE INVENTION

Conventional bed pillows to support a person's head when lying on a bed are uniformly filled with soft materials such as feathers, synthetic foam, plastic fibers, or rubber to provide uniform thickness. In private homes, such pillows are commonplace. The user selects one of a great variety of shapes, sizes, and textures of pillows and adjusts it to his or her sleeping support or comfort with varying degrees of success.

In certain situations, however, a given pillow may be used for a number of people over a period of time. This is the situation in hotels, motels, convalescent homes, and hospitals, for example. The pillow case is replaced from one person's use to another's in those facilities. The pillow itself is used over and over, regardless of the size or gender of the user.

The present invention reflects the discovery that men's shoulder, neck, and head dimensions differ from women's dimensions. In other words, men and women have different body frames. Moreover, such dimensions vary among men and among women depending on their individual physical dimensions. Therefore, a uniformly thick pillow of a predetermined thickness and stiffness is most often not the most desirable solution for every person's sleeping condition.

### DESCRIPTION OF RELEVANT ART

U.S. Pat. No. 4,768,248, issued to O'Sullivan on Sep. 6, 1988 for HEALTH PILLOW CONSTRUCTION AND METHOD THEREFOR, discloses a health pillow construction for receiving the head and neck of the user in a resting position. A cover has a first and second wall and a partition interposed between the first and second walls so as to define a first and second chamber, respectively. Soft filler material is enclosed within the first chamber for supporting the head. Enclosed within the second chamber is a firm neck support member which is slidably moveable within the second chamber, so that the neck support member can easily be shifted from one position to another within the chamber. This enables the user to adapt the pillow to provide firm support for the neck while providing satisfactory head support. The neck support member is preferably in a cylindrical roll shape and is of a firm material, such as hard latex, or polyester fiber tightly packed within a covered fabric. The neck roll preferably has a diameter approximately in the range of 20 to 30 percent of its height.

U.S. Pat. No. 8,650,683, issued to Parnhamon Feb. 18, 2014 for PILLOW, discloses a pillow having an outer cover having a first side and a second side that define therebetween a space for receiving pillow filling. First and second partition walls extend between the first side and the second side to divide the space into first, second, and third chambers, respectively. A closable access mechanism provides access to the first, second, and third chambers so that pillow filling can be selectively added to or removed from any of the chambers to adjust the firmness of portions of the pillow.

### SUMMARY OF THE INVENTION

In accordance with the invention, there is provided a rectangular pillow having a longitudinal upper border having a proximal end and a distal end and a longitudinal lower border parallel to the longitudinal upper border. A first side border is connected to the proximal ends of the upper border and the lower border. A second side border is connected to the distal ends of the upper border and the lower border. A partition is disposed parallel to the upper border and the lower border and extends between the first and second side borders, forming an upper portion and a lower portion of the pillow. A first quantity of fibrous down feathers or other conventional material fills the upper portion of the pillow and a second quantity of fibrous down feathers or other conventional material fills the lower portion of the pillow, so the upper portion of the pillow has a first thickness and stiffness or durometer and the lower portion of the pillow has a second thickness and/or stiffness or durometer. Other material can also be used, such as polyester or synthetic foam.

Labels are provided in different colors, blue for men and pink for women. A tag is sewn onto one end of the upper portion of the pillow to indicate S (small) and NI (medium) and onto one end of the lower portion to indicate L (large) and XL (extra large). Alternatively, other captions can be used, such as “Comfort Level 1,” “Comfort Level 2,” “Comfort Level 3,” etc. to identify different sizes. These labels match standard shirt sizes.

### BRIEF DESCRIPTION OF THE DRAWING

A complete understanding of the present invention may be obtained by reference to the accompanying drawing, when considered in conjunction with the subsequent detailed description, in which:

FIG. 1 is a schematic view of a person's head, neck, and shoulders;

FIG. 2 is a plan view of the pillow in accordance with the invention; and

FIG. 3 is an end view of two pillows.

### DETAILED DESCRIPTION OF THE PREFERRED EMBODIMENT

Although the following detailed description contains specific details for the purposes of illustration, those of ordinary skill in the art will appreciate that variations and alterations to the following details are within the scope of the invention. Accordingly, the exemplary embodiments of the invention described below are set forth without any loss of generality to, and without imposing limitations upon, the claimed invention.

A rectangular pillow has a longitudinal upper border and a longitudinal lower border parallel to the longitudinal upper border. The pillow has first and second side borders connected to the ends of the upper border and the lower border. A longitudinal partition, disposed parallel to the upper border and the lower border and extending between the first and second side borders, forms an upper portion and a lower portion of the pillow.

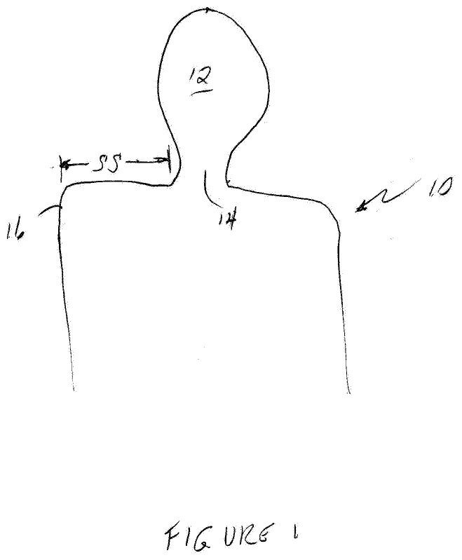

Referring now to FIG. 1, a schematic view of a person's head, neck, and shoulders is shown at reference numeral 10. Head 12, neck 14, and shoulder 16 are depicted in silhouette. The approximate distance between the person's neck 14 and shoulder 16, measured from the base of the neck 14 to the outside tip of the humerus bone is indicated by the dimension SS. The approximate, average dimension SS for women and men is shown in the Table, below, correlating to small, medium, large, and extra large sizes, as are typically found in shirts.

TABLE of Neck-to-Shoulder Dimensions (SS) and Shirt Sizes

| Women | | | | Men | | | |
|---|---|---|---|---|---|---|---|
| XL | L | M | S | XL | L | M | S |
| 6.25″ | 5.25″ | 4.25″ | 3.25″ | 7.25″ | 6.25″ | 5.25″ | 4.25″ |

Referring now also to FIG. 2, a plan view of the inventive bed pillow is identified generally by reference numeral 20. In the preferred embodiment, the pillow 20 is rectangular, having an upper border 22 and lower border 24 parallel to each other. Other boundary configurations and shapes can also be provided without departing from the scope of the invention.

Pillow 20 can be sized for single, full, queen, and king sized beds, not shown, on which the pillow 20 is to be placed.

Proximal side border 26 is attached to upper and lower borders 22, 24, as is distal side border 28. Bisecting the region between upper and lower borders 22, 24 is a fabric partition 30 that extends between proximal and distal side borders 26, 28. Partition 30 is sewn entirely through the thickness of pillow 20, forming an upper and a lower portion thereof.

A first quantity of fibrous down feathers, not shown, fills the upper portion of the pillow and a second quantity of fibrous down feathers or other conventional material, such as polyester, synthetic foam, memory foam, or combinations thereof, fills the lower portion of pillow 20, so the upper portion of pillow 20 has a first thickness and stiffness and the lower portion of pillow 20 has a second thickness and/or stiffness.

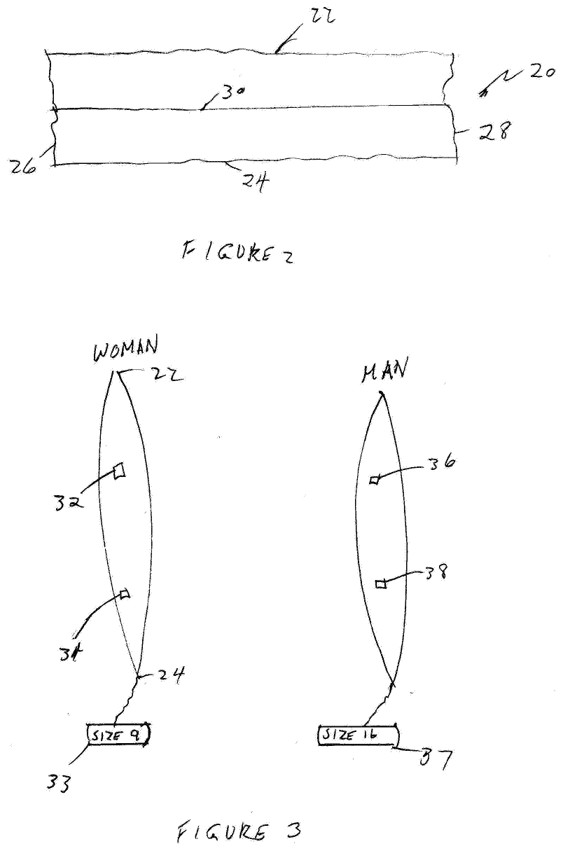

Referring now to FIG. 3, an end view of two pillows is shown. Because a woman's distance from neck to shoulder is usually less than the equivalent distance for a man, end view of the left pillow shown in this FIG. 3 is assumed to be a woman's pillow and end view of the right pillow is assumed to be a man's pillow. In the preferred embodiment of the invention, woman's pillow is dyed pink and man's pillow is dyed blue or tags 33, 37 can be attached, including women's and men's specific shirt sizes or relative sizes, respectively, and being colored as aforementioned. Of course, other colors can be chosen to differentiate the man's pillow from the woman's. Alternatively or in addition, labels 32 and 34 attached to proximal side border of woman's pillow can represent the thickness of the upper portion and lower portion of pillow, such as S and M or L and XL, respectively. Similarly, labels 36 and 38 attached to proximal side border of man's pillow can indicate the thickness of the upper portion and lower portion of pillow, such as S and M or L and XL. Alternatively, other captions can be used, such as “Comfort Level 1,” “Comfort Level 2,” “Comfort Level 3,” etc. to identify different sizes. The proximal side borders of woman's and man's pillow, not shown, can also be consistently labeled.

Accordingly, in a typical motel bedroom, four pillows would be provided on a single-, double-, queen-, or king-sized bed: two to accommodate a woman and two to accommodate a man.

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

What is claimed is:

1. A rectangular pillow comprising:
a) a longitudinal upper border having a proximal end and a distal end;
b) a longitudinal lower border parallel to said longitudinal upper border, said longitudinal lower border having a proximal end and a distal end, each of said ends being oppositely disposed to said longitudinal upper border proximal end and said longitudinal upper border distal end, respectively;
c) a first side border connected to said proximal ends of said longitudinal upper border and said longitudinal lower border;
d) a second side border connected to said distal ends of said longitudinal upper border and said longitudinal lower border;
e) a longitudinal partition parallel to said longitudinal upper border and said longitudinal lower border extending between said first and second side borders and extending entirely through the thickness of the pillow, forming an upper portion and a lower portion of said pillow; and
f) a first quantity of material filling said upper portion of said pillow and a second quantity of material filling said lower portion of said pillow;
whereby said upper portion of said pillow has a first thickness and said lower portion of said pillow has a second thickness.

2. The rectangular pillow in accordance with claim 1, wherein said first quantity of material has a greater durometer than said second quantity of material.

3. The rectangular pillow in accordance with claim 1, wherein said first thickness is between approximately 3″ and 7″.

4. The rectangular pillow in accordance with claim 1, wherein said second thickness is between approximately 3″ and 7″.

5. The rectangular pillow in accordance with claim 1, wherein said first and second materials are chosen from a set of materials consisting of: fibrous down feathers; polyester; synthetic foam; memory foam; and combinations thereof.

6. A pillow comprising:
a) an upper border having a proximal end and a distal end;
b) a lower border having a proximal end and a distal end, each of said ends being oppositely disposed to said upper border proximal end and said upper border distal end, respectively;
c) a first side border connected to said proximal ends of said upper border and said lower border;
d) a second side border connected to said distal ends of said upper border and said lower border;
e) a partition extending between said first and second side borders and extending entirely through the thickness of the pillow, forming an upper portion and a lower portion of said pillow; and
f) a first quantity of material filling said upper portion of said pillow and a second quantity of material filling said lower portion of said pillow;
whereby said upper portion of said pillow has a first thickness and said lower portion of said pillow has a second thickness.

7. The pillow in accordance with claim 6, wherein said first quantity of material has a greater durometer than said second quantity of material.

8. The pillow in accordance with claim 6, wherein said first thickness is between approximately 3″ and 7″.

9. The pillow in accordance with claim 6, wherein said second thickness is between approximately 3″ and 7″.

10. The pillow in accordance with claim 6, wherein said first and second materials are chosen from a set of materials consisting of: fibrous down feathers; polyester; synthetic foam; memory foam; and combinations thereof.

11. The pillow in accordance with claim 6, further comprising at least one label affixed to each of said portions of said pillow, said at least one label having at least one characteristic chosen from a set of characteristics consisting of: S (small); M (medium); L (large); XL (extra large); Comfort Level 1; Comfort Level 2; Comfort Level 3; blue; pink; and a shirt size.
